(19) United States
(12) Patent Application Publication
(10) Pub. No.: US 2017/0362878 A1
(43) Pub. Date: Dec. 21, 2017

(54) TOUCH CONTROL OF VEHICLE WINDOWS

(71) Applicant: Toyota Motor Engineering & Manufacturing North America, Inc., Erlanger, KY (US)

(72) Inventor: Sergei I. Gage, Redord, MI (US)

(73) Assignee: Toyota Motor Engineering & Manufacturing North America, Inc., Erlanger, KY (US)

(21) Appl. No.: 15/185,133

(22) Filed: Jun. 17, 2016

(51) Int. Cl. E05F 15/75; B60J 1/17

(52) U.S. Cl. CPC E05F 15/75; B60J 1/17

(57) ABSTRACT

A vehicle includes a vehicle door including a vehicle window and a window regulator connected to the window. An electric motor is connected to the window regulator for moving the vehicle window between an open position and a closed position. A window control system includes a window control zone that is integral with the vehicle window. The window control zone includes a touch sensor that provides a control signal to a window ECU based on an operator touch.

### TECHNICAL FIELD

The present specification generally relates to control of vehicle windows and, more specifically, to touch control of vehicle windows.

### BACKGROUND

Frequently, window control switches for vehicles may be located on doors of the vehicles, such as in an armrest area. Window control switches located on a particular door may be provided for controlling opening and closing of the window for that particular door. Additional switches may be provided on the driver door for controlling vehicle windows other than the driver door window only.

The window control switches are typically manually actuated, momentary-type switches having an UP position, a DOWN position and an OFF position, which is a rest or return to center position where a position of the window can be maintained. These window control switches may be somewhat small and have a correspondingly small actuation areas. Where multiple control switches are provided, an operator may have to feel for and identify the desired control switch. Additionally, it is not uncommon to place other control switches near the window control switches, such as door lock/unlock switches.

Accordingly, a need exists for vehicles, systems and methods that facilitate control of vehicle windows including sunroofs using touch control.

SUMMARY

In one embodiment, a vehicle includes a vehicle window. An electric motor is connected to the vehicle window for moving the vehicle window between an open position and a closed position. A window control system includes a window control zone that is integral with the vehicle window. The window control zone includes a touch sensor that provides a control signal to a window ECU based on an operator touch.

In another embodiment, a method of controlling a window of a vehicle is provided. The method includes determining that a touch sensor is actuated by an operator touch using an electronic control unit. The touch sensor is located in a window control zone that is integral with a vehicle window. Determining that the touch sensor or a different touch sensor within the window control zone is actuated by another operator touch within a predetermined time period using the electronic control unit. The electronic control unit controls an electric motor operatively connected to the vehicle window based on the step of determining that the touch sensor or a different touch sensor within the window control zone is actuated by the another operator touch within the predetermined time period.

In yet another embodiment, a vehicle includes a vehicle door including a vehicle window and a window regulator connected to the window. An electric motor is connected to the window regulator for moving the vehicle window between an open position and a closed position. A window control system includes a window control zone including a touch sensor that is located at a frame of the vehicle door that surrounds the vehicle window. The touch sensor provides a control signal to a window ECU based on an operator touch.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is an interior view of a vehicle door including window control zones, according to one or more embodiments shown and described herein;

FIG. 2 is a section view of a window control zone for the vehicle door of FIG. 1, according to one or more embodiments shown and described herein;

FIG. 3 is a section view of another window control zone for the vehicle door of FIG. 1, according to one or more embodiments shown and described herein;

FIG. 4 is a diagrammatic view of a window control system for the vehicle door of FIG. 1, according to one or more embodiments shown and described herein;

FIG. 5 is a flow diagram illustrating logic of a window ECU, according to one or more embodiments shown and described herein;

FIG. 6 illustrates the vehicle door of FIG. 1 with a vehicle window in a partially retracted position;

FIG. 7 illustrates a vehicle window control assembly that used in conjunction with a smart key-type vehicle entry system, according to one or more embodiments shown and described herein; and

FIG. 8 illustrates an interior of a sunroof including window control zones, according to one or more embodiments shown and described herein.

### DETAILED DESCRIPTION

Embodiments described herein are generally related to vehicles, systems and methods that facilitate control of vehicle windows including sunroof windows using touch control. The vehicles include a window control system that utilizes touch sensors placed on and/or around one or more windows of the vehicles that can be used to detect presence of a finger or other suitable appendage for controlling operation of the window. In some embodiments, the window control systems may be provided with the touch sensors to allow for control of the windows from only inside of the vehicles using the touch sensors. In other embodiments, the window control systems may be provided with the touch sensors to allow for control of the windows from both inside and outside of the vehicles. As one example, the window control systems may be used with an electronic key or key fob to allow for controlling of the widows using the touch sensors from outside the vehicles.

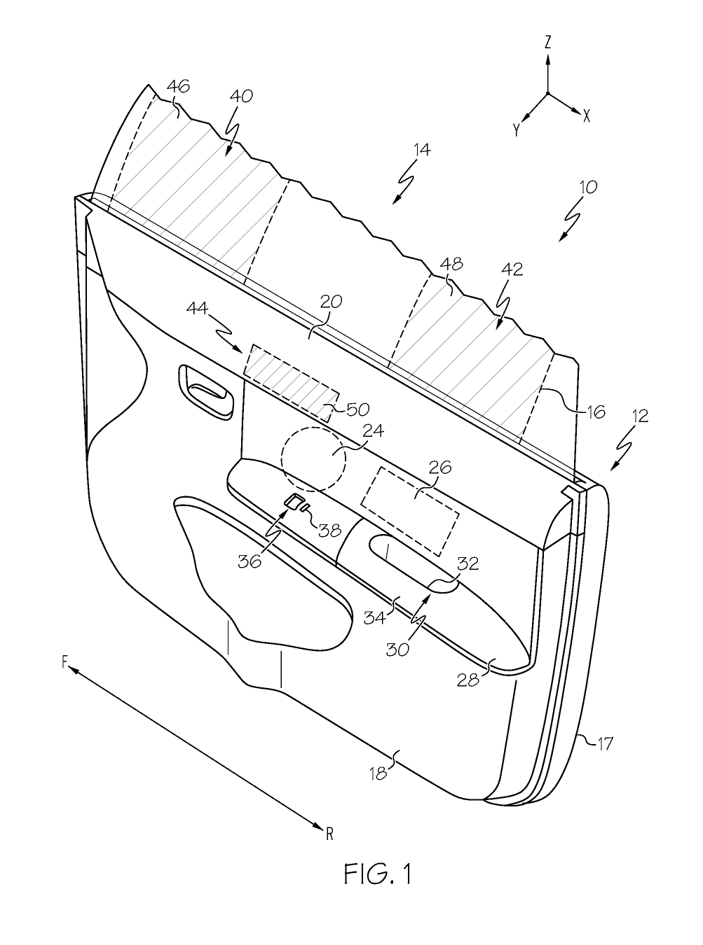

Referring to FIG. 1, a vehicle window control assembly 10 is provided with a vehicle door 12 and includes a window control system, referred to generally as element 14, that can be used to control operation of a power vehicle window 16 of the vehicle door 12. In the illustrated example, the vehicle door 12 may be a front driver's side door; however, the window control system 14 may be used to control any one or more of windows of the vehicle including any of the passenger windows, back, lift door window and/or sunroof window, which will be described in greater detail below.

The vehicle door 12 may include an outer panel 17 and an inner panel 18 that is connected to the outer panel 17 to define a volume therebetween. The outer panel 17 may be an outer visible panel of the vehicle body, while the inner panel 18 may be an interior door trim panel that is visible from inside the vehicle. The outer panel 17 and the inner panel 18 define a window frame 20 for the vehicle window 16. The vehicle window 16 may be extendable to a closed position and retractable to a open position into the volume between the outer panel 17 and the inner panel 18 using a window regulator 24 operatively connected to the vehicle window 16 and an electric motor 26 operatively connected to the window regulator 24.

The inner panel 18 may further include an armrest 28 that extends into a cabin of the vehicle. The armrest 28 may include a handle portion 30 that is provided by an opening 32 that extends into the armrest 28 in a vehicle vertical direction (+/−z). The handle portion 30 can facilitate grasping of the armrest 28 to facilitate opening and closing of the vehicle door 12. Located forward of the armrest 28 in a vehicle longitudinal direction (+/−x) is an inner handle 34. The vehicle door 12 can be unlatched and opened using the inner handle 34. Located on the armrest 28 between the inner handle 34 and the handle portion 30 may be a switch mount assembly 36. The switch mount assembly 36 may include any number of switches 38 (e.g., momentary switches) that can me moved or toggled between various positions depending on the type of switch. For example, a window control switch may be moved between UP, DOWN and OFF positions. A door lock switch may be moved between LOCK and UNLOCK positions. A window lock switch may be provided that can allow the operator to lock movement of passenger windows.

The window control system 14 includes window control zones 40, 42 and 44. While three window control zones are illustrated, there may be more or less than three window control zones depending, at least in part, on the design of the vehicle door 12 and other vehicle design considerations. In some embodiments, each window control zone 40, 42 and 44 may control a preselected operation of the vehicle window 16. For example, any one or more of the window control zones 40, 42 and 44 may control opening, stopping and/or closing of the vehicle window 16 based on operator input. In aspects, the window control zones 40, 42 and 44 may provide a control signal based on operator touch within the window control zones 40, 42 and 44. The window control zones 40, 42 and 44 may be provided with one or more touch sensors (represented by hatch lines 46, 48 and 50) that can be activated by the operator touch from within the vehicle on an interior side of the vehicle door 12 and/or from outside of the vehicle on an exterior side of the vehicle door 12, which, in turn, send a control signal to a controller for a window control operation.

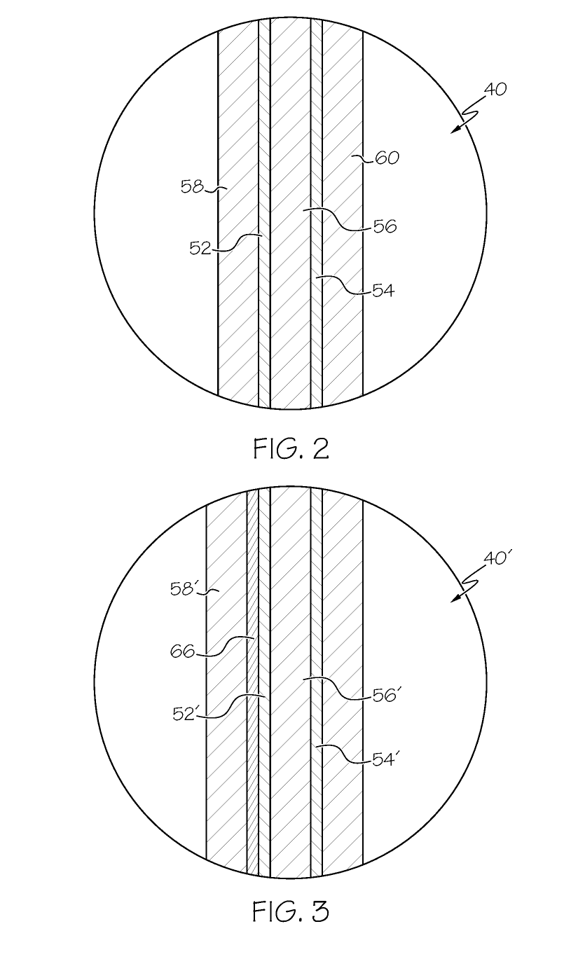

In the illustrated example, window control zones 40 and 42 are provided on the vehicle window 16 and provide operator touch areas for controlling operation of the vehicle window 16. Each window control zone 40, 42 may encompass an area of the vehicle window 16, such as at least about 10 percent, at least about 20 percent, at least about 30 percent, at least about 40 percent, at least about 50 percent, at least about 60 percent, at least about 70 percent, at least about 80 percent of the total area of the vehicle window 16. In some embodiments a window control zone may encompass the total area of the vehicle window. The window control zone 40 is shown by, for example, FIG. 2. While window control zone 40 is described, the description can apply equally to window control zone 42. Any suitable touch technology can be used, whether overlay-based or perimeter-based. In illustrated embodiment, the window control zone 40 is overlay-based with the window glass is integral to operation of the window control zone 40. The window control zone 40 may be formed as a projected capacitance window control zone 40 that relies on electrical capacitance to produce a control signal.

The window control zone 40 may be formed of a first conductive layer 52 and a second conductive layer 54. An insulator layer 56 may be provided that may be any suitable insulator, such as a glass layer. The first and second conductive layers 52 and 54 may be formed of transparent conductors, such as transparent indium tin oxide (ITO). Each conductor may be scanned separately to identify multiple simultaneous touch points. Outer layers of window glass may provide protective layers 58 and 60 and provide outer and inner touch surfaces 64 and 62 of the vehicle window 16. The window control zone 40 of the vehicle window 16 may be a two-way touch window control zone 40 that allows for touch control using either outer or inner touch surfaces 62 and 64. Indicia may or may not be provided to highlight the window control zone 40.

Referring to FIG. 3, in another embodiment, the window control zone 40′ may be formed as a one-way touch window control zone 40′. In this embodiment, the window control zone 40′ may include the first and second conductor layers 52′ and 54′ separated by the insulator layer 56′, as described above. In this embodiment, an additional transparent insulator layer 66 may provide a barrier between the outer protective layer 58′ and the conductor layer 52′, which prevents human interaction with the first and second conductive layers 52′ and 54′ via the outer touch surface 64′.

Referring back to FIG. 1, the window control zone 44 may be provided on the inner panel 18 of the vehicle door 12. In the illustrated example, the window control zone 44 may be provided at the window frame 20. The window control zone 44 may include one or more touch sensors 50 positioned along a periphery of the window frame 20. For example, the touch sensors 50 may be positioned along any one or more of a bottom portion of the window frame 20, a top portion of the window frame 20, a front side portion of the window frame 20 and/or a rear side portion of the window frame 20. The touch sensors 50 may be provided along the window frame 20 so that a specific region, regions or the entire periphery of the window frame 20 can be responsive to the touch of the operator. The touch sensors 50 may be any suitable type of touch sensor, such as capacitance sensors, resistance sensors, piezoelectric sensors, etc. Indicia may or may not be provided to highlight the window control zone 44.

While indicia may be provided to highlight the window control zones 40, 42 and 44, in other embodiments, the window control zones may not be visually detectable as they are part of the vehicle door structure. To accomplish this, the window control zones 40 and 44 may be formed of components that are transparent and/or not readily discernible visually, for example, due to their size. Window control zone 44 may include touch sensors 50 that are part of and/or located behind outer surfaces of the inner panel 18 of the vehicle door 12, but, nonetheless, be actuated through operator touch.

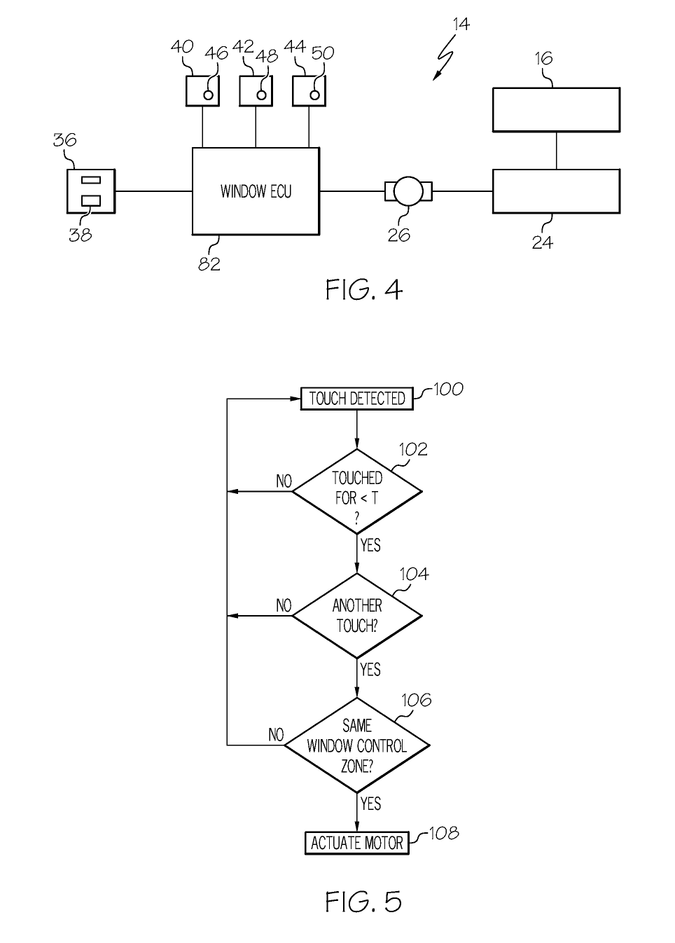

FIG. 4 illustrates components of the window control system 14. The window control system 14 includes the window control zones 40, 42 and 44 with touch sensors 46, 48 and 50. The touch sensors 46, 48 and 50 are operatively connected to a window electronic control unit (ECU) 82. The switch mount assembly 36 including the switches 38 may also be operatively connected to the window ECU 82. The window ECU 82 is connected to the electric motor 26, which, in turn, actuates the window regulator 24 that is connected to the vehicle window 16 for extending and retracting the vehicle window 16.

In some embodiments, the window control system 14 may utilize one or more preselected operator input sequences using the touch sensors 46, 48 and 50, as opposed to a single touch of any duration. As one example, the window ECU 82 may utilize logic saved in memory as machine-readable instructions that looks for multiple operator contacts or taps with the touch sensors 46, 48 and 50 in controlling operation of the electric motor 26. In particular, the window ECU 82 may require a double-tap of any one or more of the touch sensors 46, 48 and 50 within a predetermined interval before controlling operation of the electric motor 26.

Referring to FIG. 5, a flow diagram illustrating logic for the window ECU 82 controlling operation of the vehicle window 16 is provided based on multi-touching a touch sensor 46, 48 and 50 within a window control zone 40, 42 and 44. At step 100, it is determined that one of the touch sensors 46, 48 and 50 is actuated by an operator touch. At step 102, it is determined if the touch sensor 46, 48 and 50 within a window control zone 40, 42 and 44 is touched for less than a predetermined time period (e.g., at most about ¼ second) corresponding to a tap. If it is determined the touch sensor 46, 48, 50 is touched or pressed for more than the predetermined time period, the operator touch is not considered a tap and the logic returns to step 100. If the touch sensor 46, 48, 50 is touched or pressed for less than the predetermined time period, the operator touch is considered a tap and the logic proceeds to step 104. At step 104, it is determined whether a touch sensor 46, 48, 50 of the window control zone 40, 42, 44 is touched within a predetermined time period (e.g., at most about ½ second). If a touch sensor 46, 48, 50 is not touched within the predetermined time period, the logic returns to step 100. If a touch sensor 46, 48, 50 is touched within the predetermined time period, it is determined whether the touch sensor 46, 48, 50 within the same window control zone 40, 42, 44 is touched as touched in step 100 at step 106. If the touch sensor 46, 48, 50 touched in step 104 is in a different window control zone 40, 42, 44, the logic returns to step 100. If the touch sensor 46, 48, 50 touched in step 106 is in the same window control zone 40, 42, 44, it is determined if the touch sensor 46, 48, 50 is touched for less than a predetermined time period (e.g., at most about ¼ second) corresponding to a tap. If it is determined that the touch sensor 46, 48, 50 is touched for more than the predetermined time period, the occupant touch is not considered a tap and the logic returns to step 100. If, however, the touch sensor 46, 48, 50 is touched or pressed for less than the predetermined time period, the occupant touch is considered a tap and the electric motor 26 is actuated and the window is extended, retracted or stopped at step 108.

Referring back to FIG. 1, in some embodiments, the window control zones 40, 42 and 44 may provide for different window control operations for controlling operation of the vehicle window 16. For example, the window control zone 40 may be used for opening the vehicle window 16, window control zone 42 may be used for closing the vehicle window 16 and window control zone 44 may also be used for closing the vehicle window 16. Any other suitable arrangement can be used having any combination of opening, closing and stopping functions. For example, a single window control zone may be provided that opens or closes the window based on the previous operation, which can be saved in memory of or otherwise tracked by the window ECU 82. For example, the window ECU 82 may alternate between an opening operation, stopping operation and closing operation using input from only a single window control zone.

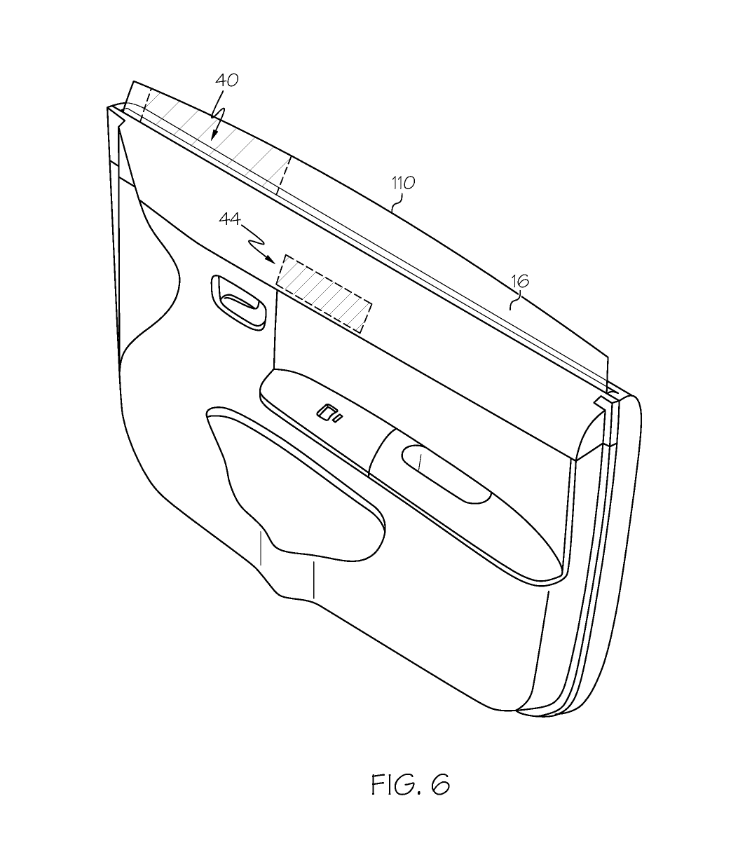

FIG. 6 illustrates the vehicle window 16 in a partially open configuration. As the vehicle window 16 retracts into the interior volume of the vehicle door 12, one or more of the window control zones 40, 42 may also retract into the volume and be inaccessible to the operator. In these instances, window control zone 40 positioned at an upper periphery 110 of the vehicle window 16 and/or the window control zone 44 positioned along the window frame 20 may be desirable and provide an exposed window control zone, even with the vehicle window 16 in a fully retracted position.

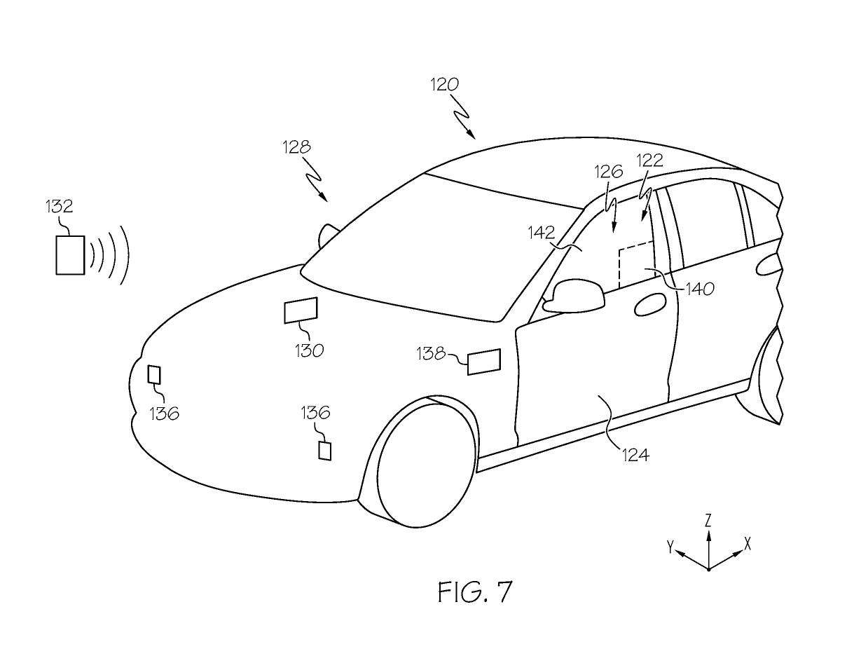

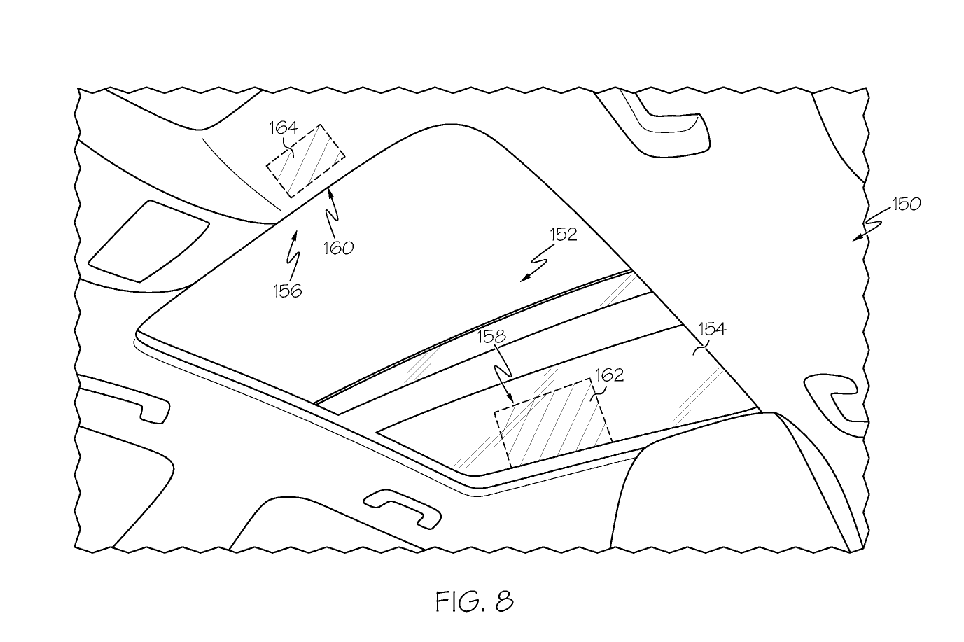

While the above examples may relate to window controlling operation using the window control zones 40, 42, 44 from within the vehicle, the window control system 14 may be used from outside the vehicle in some embodiments. Referring to FIG. 7, a vehicle 120 includes a vehicle window control assembly 122 that is provided with a vehicle door 124 and includes a window control system 126. The vehicle window control assembly 122 may be used in conjunction with a smart key-type vehicle entry system, referred to generally as element 128.

The smart key vehicle entry system 128 may include a smart key ECU 130 that can communicate with a key fob 132 to lock and unlock vehicle door locks 134. The key fob 132 may be a transponder that can communicate with the smart key ECU 130 via various antennas 136, which may be located at various positions on the vehicle 120. The antennas 136 may periodically send a signal in a polling fashion that causes the key fob 132 to reply with a unique security code, which is received by the smart key ECU 130 when the key fob 132 is within a predetermined range of the vehicle 120. Once the security code is received and verified by the smart key ECU 130, the smart key ECU 130 may communicate with a window ECU 138 to activate the window control system 126.

As discussed above, in some embodiments, a window control zone 140 may be provided that is a two-way window control zone. That is, the window control zone 140 may allow for touch control of a vehicle window 142 from outside, as well as from inside, the vehicle 120. As above, the window control zone 140 may be overlay-based or perimeter based. In this example, the window control zone 140 may be overlay-based including the conductive layers, insulator layer and protective layers thereby forming touch sensors, as described above in FIG. 2. In this embodiment, once the smart key ECU 130 communicates presence of the key fob 132, the window ECU may look for multiple operator contact (e.g., a double-tap) within the window control zone 140 in a fashion similar to that described above.

Referring to FIG. 8, a vehicle 150 includes a vehicle window control assembly 152 that is provided with a sunroof 154 and includes a window control system 156. The window control system 156 includes one or more window control zones 158 and 160. While two window control zones are illustrated, there may be more or less than three window control zones depending, at least in part, on the design of the sunroof 154 and other vehicle design considerations. The window control zones 158 and 160 may provide a control signal based on operator touch within the window control zones 158 and 160. The window control zones 158 and 160 may be provided with one or more touch sensors (represented by hatch lines 162 and 164) that can be activated by the operator touch from within the vehicle on an interior side of the sunroof 154, which, in turn, send a control signal to a controller for a window control operation in a fashion similar to that described above.

The above-described window control assemblies including the window control systems can allow operator control of vehicle windows by operator touch within a window control zone. The window control zone can be part of the window itself or located along a frame of the window. The window control zones can provide an increased area for window control compared to momentary switches, as the entire window control zone area can be provided with the touch sensors. The window control systems can be used in conjunction with other vehicle systems, such as smart key vehicle entry systems and gesture identification systems. For example, a window control system may only activate based on an operator input, such as a gesture or voice command. While an overlay-based projected capacitance window control zone is described primarily above, other window control zones may be used, such as resistive touch and beam break sensors or cameras that may or may not be embedded in the frame of the vehicle window.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a vehicle window;
an electric motor connected to the vehicle window for moving the vehicle window between an open position and a closed position; and
a window control system comprising a window control zone that is integral with the vehicle window and intersects a peripheral edge of the vehicle window, the window control zone comprising a touch sensor that provides a control signal to a window ECU based on an operator touch.

2. The vehicle of claim 1, wherein the window control zone is formed as a projected capacitance window control zone comprising the touch sensor.

3. The vehicle of claim 2, wherein the window control zone comprises a first conductive layer, a second conductive layer and an insulator layer located between the first conductive layer and the second conductive layer.

4. The vehicle of claim 1, wherein the touch sensor of the window control zone provides the control signal in response to the operator touch from an interior side of the vehicle door and from an exterior side of the vehicle door.

5. The vehicle of claim 1, wherein the touch sensor of the window control zone provides the control signal in response to the operator touch from only an interior side of the vehicle.

6. The vehicle of claim 1 further comprising a smart key vehicle entry system comprising a smart key ECU that receives a signal from a key fob and communicates with the window ECU in response to the signal from the key fob.

7. The vehicle of claim 1, wherein the window control zone is a first window control zone, the vehicle further comprising a second window control zone that is spaced from the first window control zone, the second window control zone comprising a touch sensor that provides a control signal to a window ECU based on an operator touch.

8. The vehicle of claim 7, wherein the second window control zone is located at a frame of the vehicle door that surrounds the vehicle window.

9. The vehicle of claim 8, wherein the touch sensor comprises a capacitive touch sensor.

10. The vehicle of claim 1, wherein the window ECU includes logic that controls the electric motor based on multiple operator contact with the touch sensor within a predetermined time period.

11. A method of controlling a window of a vehicle, the method comprising:
determining that a touch sensor is actuated by an operator touch using an electronic control unit, the touch sensor being located in a window control zone that is integral with a vehicle window and intersects a peripheral edge of the vehicle window;
determining that the touch sensor or a different touch sensor within the window control zone is actuated by another operator touch within a predetermined time period using the electronic control unit; and
the electronic control unit controlling an electric motor operatively connected to the vehicle window based on the step of determining that the touch sensor or a different touch sensor within the window control zone is actuated by the another operator touch within the predetermined time period.

12. The method of claim 11, wherein the window control zone is formed as a projected capacitance window control zone comprising the touch sensor.

13. The method of claim 12, wherein the window control zone comprises a first conductive layer, a second conductive layer and an insulator layer located between the first conductive layer and the second conductive layer.

14. The method of claim 11, wherein the touch sensor of the window control zone providing a control signal in response to the another operator touch from an interior side of the vehicle door.

15. The method of claim 11, wherein the touch sensor of the window control zone providing a control signal in response to the another operator touch from an exterior side of the vehicle door.

16. The method of claim 11, wherein the window control zone is a first window control zone, the vehicle further comprising a second window control zone that is spaced from the first window control zone, the second window control zone comprising a touch sensor that provides a control signal to a window ECU based on an operator touch.

17. The method of claim 16, wherein the second window control zone is located at a frame of the vehicle door that surrounds the vehicle window, the touch sensor comprising a capacitive touch sensor.

18. A vehicle comprising:
a vehicle door comprising
a vehicle window;
a window regulator connected to the window; and
an electric motor connected to the window regulator for moving the vehicle window between an open position and a closed position; and
a window control system comprising a window control zone comprising a touch sensor that is integral with the vehicle window and intersects more than one peripheral edge of the vehicle window, the touch sensor provides a control signal to a window ECU based on an operator touch.

19. The vehicle of claim 18, wherein the window control zone is a first window control zone, the vehicle further comprising a second window control zone comprising a touch sensor that is located at a frame of the vehicle door that surrounds the vehicle window.

20. The vehicle of claim 18, wherein the touch sensor of the window control zone provides the control signal in response to the operator touch from an interior side of the vehicle door and from an exterior side of the vehicle door.
